(19) United States
(12) Patent Application Publication
(10) Pub. No.: US 2015/0324161 A1
(43) Pub. Date: Nov. 12, 2015

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Yuichiro Shibuya, Abiko-shi (JP)

(21) Appl. No.: 14/701,827

(22) Filed: May 1, 2015

(30) Foreign Application Priority Data
May 8, 2014 (JP) 2014-097109

(51) Int. Cl. G06F 3/12

(52) U.S. Cl. CPC G06F 3/1273; G06F 3/1203; G06F 3/1274; G06F 3/122

(57) ABSTRACT

An image is stored in a memory, and the stored image is printed. A log is generated for the stored image, and the generated log and the image are transmitted to an external device. The stored image is deleted after the transmission and the printing are completed.

### BACKGROUND OF THE INVENTION

1. Field of the Invention

The present invention relates to a technique for registering a log of an image.

2. Description of the Related Art

Conventionally, upon copying, transmission, printing, and the like, all image data is stored on an image processing apparatus. Image processing systems in which it is possible to understand what kind of processing was performed, when it was performed, where it was performed, and by whom it was performed by confirming the data stored in the image processing apparatus are known. By managing images on this kind of a system, it is possible to investigate/track afterwards what kind of image processing apparatus an original for which information leakage occurred was processed on by a system administrator confirming target image data (Japanese Patent Laid-Open No. 2006-330939).

Also, a configuration in which, in an image processing system including an image processing apparatus, such as a printer which comparatively does not hold a large capacity of storage, PDL format data is transferred to the image processing server directly from a host computer that generates a print job has been proposed.

In image forming apparatuses comprising a conventional image log function, upon execution of a print job, image data is copied from a storage area for image formation to a storage area for the image log. With this configuration, because image data is held in duplicate, extra storage area space is necessary.

### SUMMARY OF THE INVENTION

The present invention was conceived in view of these kinds of problems, and provides a technique for realizing printing and log recording with less capacity as compared to conventionally required capacity.

According to the first aspect of the present invention, there is provided an image processing apparatus, comprising: a storage unit configured to store an image; a print unit configured to print the image stored by the storage unit; transmission unit configured to generate a log for the image stored by the storage unit, and transmit the generated log and the image to an external device; and a deletion unit configured to delete the image stored by the storage unit after the transmission and the printing are completed.

According to the second aspect of the present invention, there is provided an image processing method that an image processing apparatus performs, the method comprising: a storage step of storing an image in a memory; a print step of printing the image stored in the memory; a transmission step of generating a log for the image stored in the memory, and transmitting the generated log and the image to an external device; and a deletion step of deleting the image stored in the memory after the transmission and the printing are completed.

According to the third aspect of the present invention, there is provided a non-transitory computer-readable storage medium storing a computer program for causing a computer to execute: a storage step of storing an image in a memory; a print step of printing the image stored in the memory; a transmission step of generating a log for the image stored in the memory, and transmitting the generated log and the image to an external device; and a deletion step of deleting the image stored in the memory after the transmission and the printing are completed.

Further features of the present invention will become apparent from the following description of exemplary embodiments (with reference to the attached drawings).

### BRIEF DESCRIPTION OF THE DRAWINGS

FIG. 1 is a view for illustrating an example configuration of a system.

FIG. 2 is a block diagram for showing an example of a hardware configuration of a computer.

FIG. 3 is a block diagram for showing an example of a hardware configuration of a printer 1005.

FIG. 4 is a flowchart for showing processing that the printer 1005 performs.

FIG. 5 is a view for illustrating an example configuration of a job management table.

FIG. 6 is a view for illustrating an example configuration of a log table.

FIG. 7 is a flowchart for showing processing that the printer 1005 performs.

FIG. 8 is a flowchart for showing processing that the printer 1005 performs.

FIG. 9 is a flowchart for showing processing that the printer 1005 performs.

### DESCRIPTION OF THE EMBODIMENTS

Embodiments of the present invention will be described hereinafter in detail, with reference to the accompanying drawings. Note that embodiments described below merely illustrate examples of specifically implementing the present invention, and are only specific embodiments of a configuration defined in the scope of the claims.

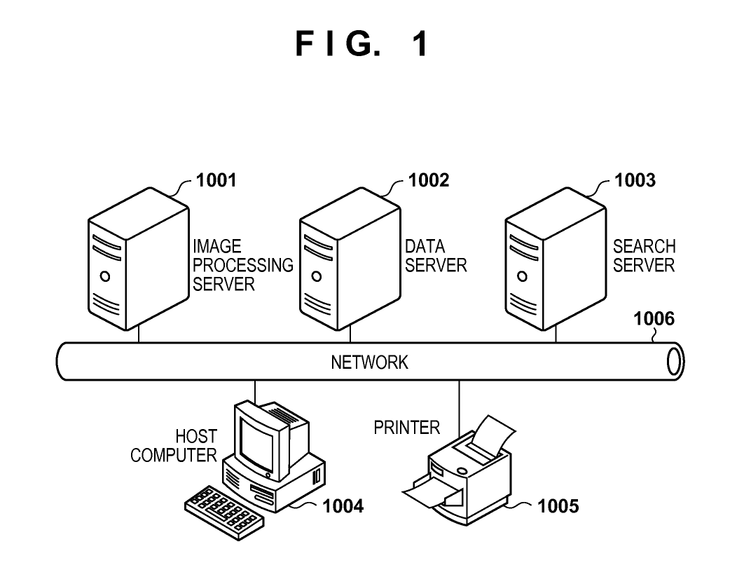

Firstly, explanation is given using FIG. 1 for an example configuration of a system used hereinafter in embodiments. Note that the configuration shown in FIG. 1 is merely one example employed to explain embodiments, and it will be clear if one is skilled in the art that there are various configurations other than the configuration shown in FIG. 1 that are applicable to embodiments from the explanation of the embodiments.

As is shown in FIG. 1, a system comprises an image processing server 1001, a data server 1002, a search server 1003, a host computer 1004, and a printer 1005 which is an image processing apparatus, and each apparatus is connected to a network 1006.

The network 1006 is comprised of a LAN, the Internet, or the like. The host computer 1004, the image processing server 1001, the data server 1002, the search server 1003, and the printer 1005 can perform data communication with each other via the network 1006.

The printer 1005, in addition to performing printing based on a print job transmitted from the host computer 1004, generates a log (job history information) corresponding to the print job, and transmits the generated log and the print job to the image processing server 1001. In the log corresponding to the print job, various information such as, for example, identification information of the device or user that instructed the execution of the print job, the date/time of the execution of the print job, identification information of the printer 1005, the type of the print job, or the like, is included. Also, a thumbnail of a print target image which is based on the print job may be included in the log.

The image processing server 1001 generates registration data from the print job when the print job and the log are received from the printer 1005, and registers the registration data and the log in the data server 1002. For example, OCR processing is performed on the print target image that is based on the print job and thereby a character string in the print target image is recognized, and the recognized character string is registered in the data server 1002 as the registration data along with the log. Also, for example, the format of the print target image based on the print job is converted, and it is registered to the data server along with the log.

The data server 1002 is a database for registering the registration data and the log for each print job. However, the data server 1002 need not be a database, and may be a file system, for example, if it is possible to realize functions equivalent or greater than those of a database.

Note that information registered on the data server 1002 may be saved persistently, or the information may be deleted if a predetermined condition is satisfied. For example, the data server 1002 may search at regular intervals through the information for which a predetermined interval has elapsed from when the information was registered to the data server 1002, and the information that is found in the search is deleted.

The search server 1003 is an apparatus that executes search processing on data registered in the data server 1002. For example, when a character string is registered as registration data for a print job in the data server 1002, the search server 1003 searches for a character string that matches a character string that a user inputs as a query by referring to the character string for the print job. Then, the search server 1003 displays the character string that was searched, and in addition to the character string, displays as a search result one or more information items in the log registered in the data server 1002. Also, for example, the search server 1003 displays after searching out a log in the data server 1002 that matches information designated by the user, such as identification information of the device or user that instructed the execution of the print job, the date/time of the execution of the print job, the type of the print job, or the like.

Note that the devices shown in FIG. 1 are not limited to individual apparatuses, and configuration may be taken such that two or more of these device are realized by a single device. For example, the image processing server 1001 and the data server 1002 may be comprised in a single device. Also, the search server 1003 and the host computer 1004 may be comprised in a single device.

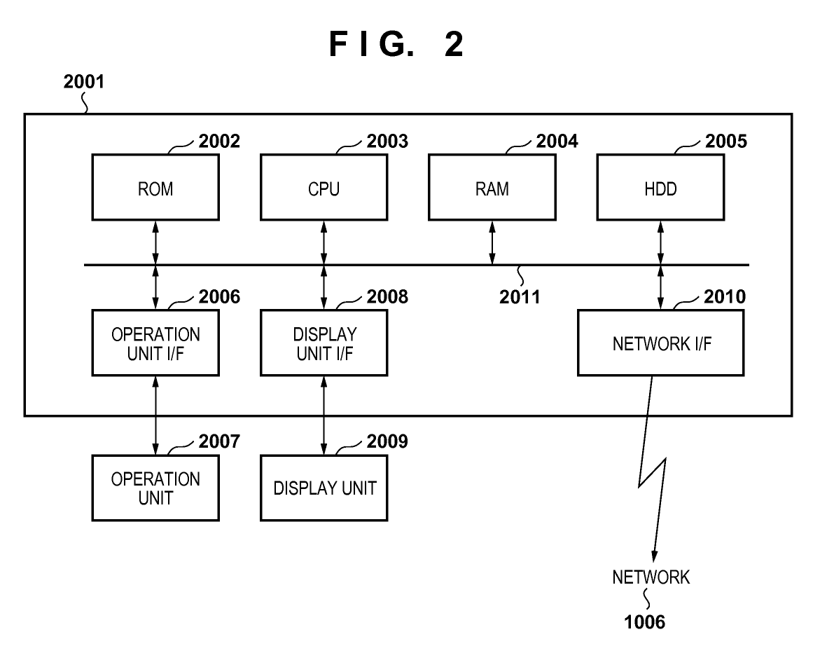

Next, explanation is given using the block diagram of FIG. 2 for a hardware configuration example of a computer that can be adopted for the host computer 1004, the image processing server 1001, the data server 1002 and the search server 1003. Note that various configurations can be considered for computer hardware configurations that can be applied to the host computer 1004, the image processing server 1001, the data server 1002, and the search server 1003, and no limitation is made to the configuration shown in FIG. 2. Also, in the following explanation, explanation is given assuming that all of the host computer 1004, the image processing server 1001, the data server 1002, and the search server 1003 have the configuration shown in FIG. 2. However, the present invention is not limited to each of the devices having the same configuration, and each may have a different configuration.

A CPU 2003, by executing processing using computer programs and data stored in a RAM 2004, a ROM 2002, or the like, performs operation control of the computer on the whole, and also executes each process which is explained as being something that the device to which the computer is applied performs.

In the ROM 2002, setting data, a boot program, or the like, of the computer is stored.

The RAM 2004 has an area for storing computer programs and data loaded from an HDD (hard disk drive) 2005, and data received from an external device (external device) via a network I/F (interface) 2010. Furthermore, the RAM 2004 has an area for storing various data that is input by the user operating an operation unit 2007, and a work area that is used when the CPU 2003 executes various processing. In this way, the RAM 2004 is able to provide various areas as appropriate.

In the HDD 2005, an OS (operating system), computer programs by which the CPU 2003 can cause processing, which is explained as being performed by the device to which the computer is applied, to be executed, and data are stored. For example, when the computer is applied to the host computer 1004, application software for generating images, documents, or the like, and driver software for the printer 1005 are saved in the HDD 2005.

The computer programs and data saved in the HDD 2005 are loaded into the RAM 2004 as appropriate in accordance with control by the CPU 2003, and these become targets of processing by the CPU 2003.

An operation unit I/F 2006 functions as an interface for connecting the operation unit 2007 to a computer main body 2001. Various information and instructions that the user inputs by operating the operation unit 2007 is transmitted towards the CPU 2003, or the RAM 2004 via the operation unit I/F 2006. The operation unit 2007 is configured of a keyboard, a mouse, or the like, and various instructions and information can be input by the user operating the operation unit 2007.

A display unit I/F 2008 functions as an interface for connecting a display unit 2009 to the computer main body 2001. A signal of an image or text is transmitted towards the display unit 2009 via the display unit I/F 2008 as a result of processing by the CPU 2003. The display unit 2009 is comprised of a CRT, a liquid crystal screen, or the like, and the display unit 2009 is able to display a result of processing by the CPU 2003, such as an image, text, or the like.

The network I/F 2010 functions as an interface for connecting the computer main body 2001 to the network 1006 described above. The computer main body 2001 can perform data communication with a device on the network 1006 via the network I/F 2010.

Each of the ROM 2002, the CPU 2003, the RAM 2004, the HDD 2005, the operation unit I/F 2006, the display unit I/F 2008, and the network I/F 2010 in the computer main body 2001 are connected to a common bus 2011.

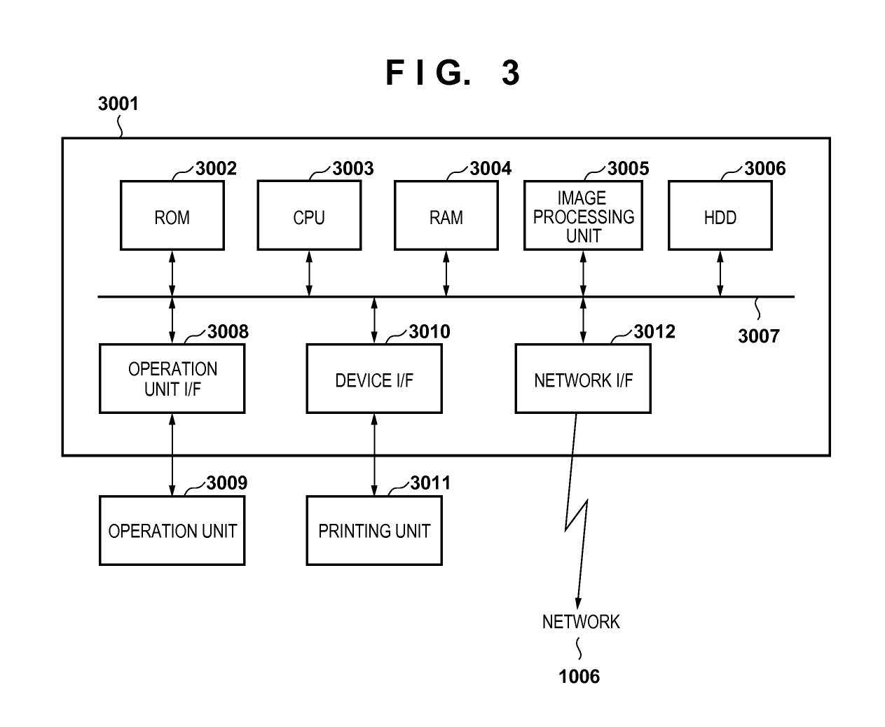

Next, explanation is given using the block diagram of FIG. 3 for a hardware configuration example of the printer 1005. Note that it can be considered that various configurations can be applied for the hardware configuration of the printer 1005, and configuration may be taken such that a different configuration is employed if the configuration is equivalent or greater than the configuration shown in FIG. 3.

A CPU 3003, by executing processing using computer programs and data stored in a RAM 3004, a ROM 3002, or the like, performs operation control of the printer 1005 on the whole, and also executes each process which is explained as being something that the device to which the printer 1005 is applied performs.

In the ROM 3002, computer programs for which rewriting is not necessary and data, such as setting data, a boot program of the printer 1005, basic operation programs of the printer 1005, or the like, is stored.

The RAM 3004 comprises an area for storing computer programs and data loaded from an HDD 3006, and various data such as print jobs received from the host computer 1004 via a network I/F 3012, or the like. Also, the RAM 3004 comprises a work area used when the CPU 3003 or an image processing unit 3005 execute various kinds of processing. In this way, the RAM 3004 is able to provide various areas as appropriate.

The image processing unit 3005 functions as a functional unit such as an RIP, an image compression unit, a color space conversion unit, an image rotation unit, a resolution conversion unit, a tone conversion unit, a printer image processing unit, or the like, for an image such as a print target image based on a print job that is printed in the printer 1005. The RIP expands PDL code into a bitmap image. The image compression unit performs JPEG compression/decompression processing for multi-valued image data, and JBIG compression/decompression processing for binary image data. The resolution conversion unit performs resolution conversion processing on image data in memory (the RAM 3004, the HDD 3006, or the like), and saves in memory. The color space conversion unit converts YUV image data in the memory into Lab image data, for example, by a matrix operation, and saves the result in memory. The tone conversion unit converts 8 bit, 256 tone image data in memory into 1 bit, 2 tone image data, for example, by an approach such as error diffusion processing, and saves the result in memory. The printer image processing unit performs correction, processing, and editing on image data. The image rotation unit rotates image data, and saves the result in memory. It is possible that each of these operates consecutively. For example, in a case where image rotation and resolution conversion is performed on image data in memory, both processes can be performed without going through the memory. Of course, the functions of the image processing unit 3005 are not limited to these.

In the HDD 3006, an OS (operating system), computer programs by which the CPU 3003 causes processing, which is explained as being performed by the printer 1005, to be executed, and data are stored. The computer programs and data saved in the HDD 3006 are loaded into the RAM 3004 as appropriate in accordance with control by the CPU 3003, and these become targets of processing by the CPU 3003.

An operation unit I/F 3008 functions as an interface for connecting an operation unit 3009 to a printer main body 3001. Various information and instructions that the user inputs by operating the operation unit 3009 are transmitted towards the CPU 3003, or the RAM 3004 via the operation unit I/F 3008.

The operation unit 3009 is comprised of hard keys, a liquid crystal screen, a touch panel screen, or the like, and the operation unit 3009 provides an operation unit that a user operates in order to input various instructions, and a display unit for displaying various information.

A device I/F 3010 functions as an interface between a bus 3007 and a printing unit 3011, and data transmission/reception is performed with the printing unit 3011 via the device I/F 3010. The printing unit 3011 is comprised of a mechanical unit for performing the printing, and a functional unit for performing printing based on print data.

The network I/F 3012 functions as an interface for connecting the printer 1005 to the network 1006 described above. The printer 1005 can perform data communication with a device on the network 1006 via the network I/F 3012.

The ROM 3002, the CPU 3003, the RAM 3004, the image processing unit 3005, the HDD 3006, the operation unit I/F 3008, the device I/F 3010, and the network I/F 3012 in the printer main body 3001 are all connected to the common bus 3007.

### First Embodiment

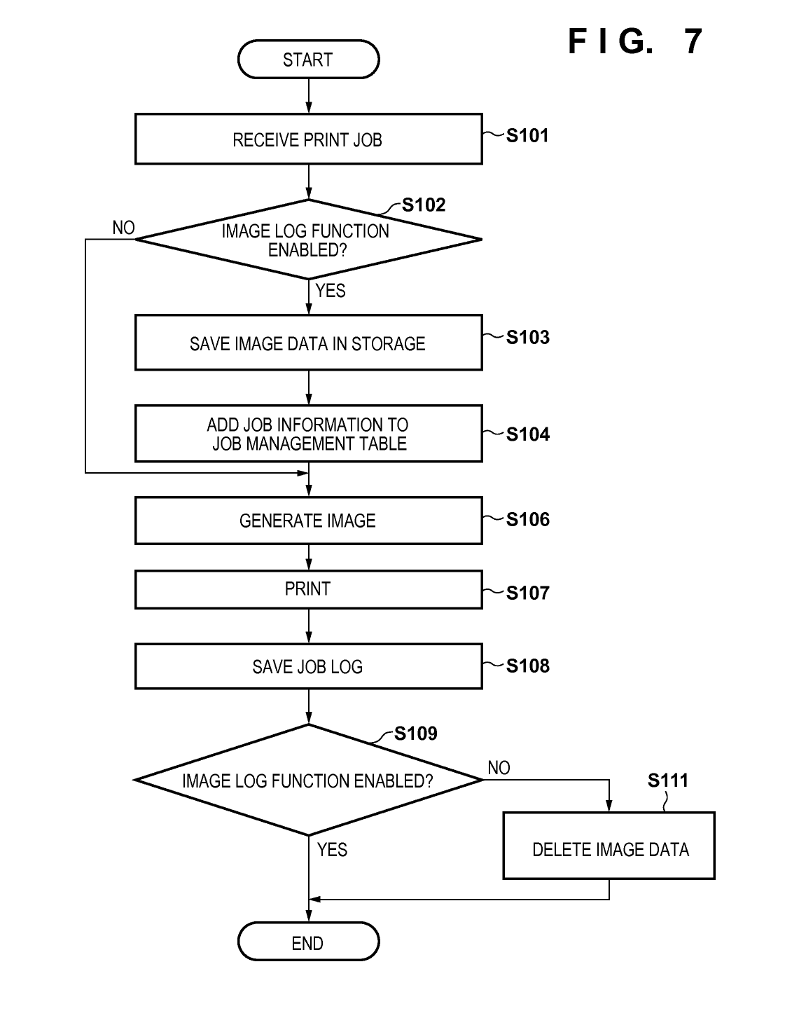

In the present embodiment, the printer 1005 prints a print target image (a header including information concerning the print target image, print settings and the like is added) which is received as a print job from the host computer 1004. In addition to this, the printer 1005 generates a log for the print target image, and transmits these to the image processing server 1001. Explanation is given for processing that the printer 1005 according to the present embodiment performs using FIGS. 7-9 which show flowcharts for the same processing.

When, in step S101, the CPU 3003 receives a print target image which is transmitted as a print job from the host computer 1004 via the network I/F 3012, the print target image is first stored in the RAM 3004.

Then the CPU 3003, in step S102, determines whether an image log function currently set for the printer 1005 is “enabled” or whether it is “disabled”. The image log function is a function whereby a log for a print target image is generated and transmitted towards the image processing server 1001. The user can set the image log function to be “enabled” and can set the image log function to be “disabled” by operating the operation unit 3009. Of course the approach to setting the image log function to be enabled/disabled is not limited to this, and the CPU 3003 may set the image log function in accordance with the type of the print job received from the host computer 1004.

If the result of the determination of step S102 is that the image log function is “enabled”, the processing proceeds to step S103. On the other hand, if the image log function is “disabled”, the processing proceeds to step S106.

In step S103, the CPU 3003 moves the print target image, which is temporarily stored in the RAM 3004 in step S101, into a queue in the HDD 3006 (storage control). In this queue, print target images are registered in the order that they were input into the printer 1005. Hereinafter it is assumed that only one print target image (the print target image stored in step S103) is registered in the queue in order to simplify the explanation.

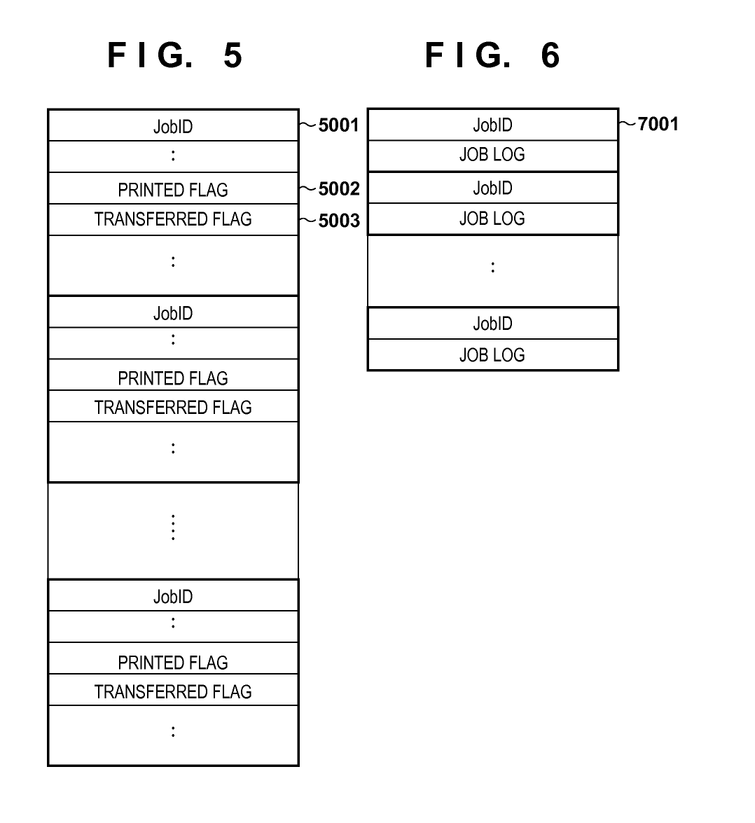

In step S104, the CPU 3003 registers information for the print job received this time in the job management table. Explanation is given for an example configuration of the job management table using FIG. 5.

As shown in FIG. 5, information corresponding to each print job is registered in the job management table 5001. In FIG. 5, a JobID, which is information that is unique to the print job and a printed flag 5002 (whose initial value is “disabled” which corresponds to being not yet printed) which is a flag that indicates whether or not the print job is printed is registered. Also, a transferred flag 5003 which is a flag that indicates whether or not a log of the print job is already transferred to the image processing server 1001 (the initial value is “disabled” which means the log is not yet transferred) is registered. The job management table 5001 is stored in the HDD 3006.

In step S106, the CPU 3003 causes data of a print format that the printing unit 3011 can interpret to be generated from the print target image by controlling the image processing unit 3005. The print target image is a print target image that is stored in the RAM 3004, or is the first print target image in the queue in the HDD 3006.

In step S107, the CPU 3003 sends data of the print format generated in step S106 towards the printing unit 3011, causing the printing unit 3011 to execute printing based on the data. Note that in a case where the image log function described above is “enabled”, the CPU 3003, in step S107, updates the printed flag 5002 to be “enabled” in the information registered in the job management table in step S104.

In step S108, the CPU 3003 generates a log for the print job received this time, and registers the generated log in the log table. Explanation is given for an example configuration of the log table using FIG. 6. As shown in FIG. 6, in the log table 7001, for each print job, a JobID which is information that is unique to the print job, and a job log, which is a log for the print job, are registered. The log table 7001 is stored in the HDD 3006.

In step S109, the CPU 3003 determines whether the image log function is “enabled” or “disabled”. If the result of this determination is that the image log function is “enabled”, the processing according to the flowchart of FIG. 7 completes. On the other hand, if the image log function is “disabled”, the processing proceeds to step S111. In step S111, the CPU 3003 deletes the print target image which was stored in the RAM 3004 in step S101 and held in the RAM 3004 as is.

After the processing according to the flowchart of FIG. 7 completes, the CPU 3003, in step S401, determines whether or not a predetermined condition is satisfied. The default condition may be that the current date/time matches a date/time scheduled in advance based on a timer function in the CPU 3003, or that a remaining capacity in the HDD 3006 is less than or equal to a predetermined amount. If the result of the determination is that the condition is satisfied, the processing proceeds to step S402, and if the result of the determination is that the condition is not satisfied, the processing returns to step S401.

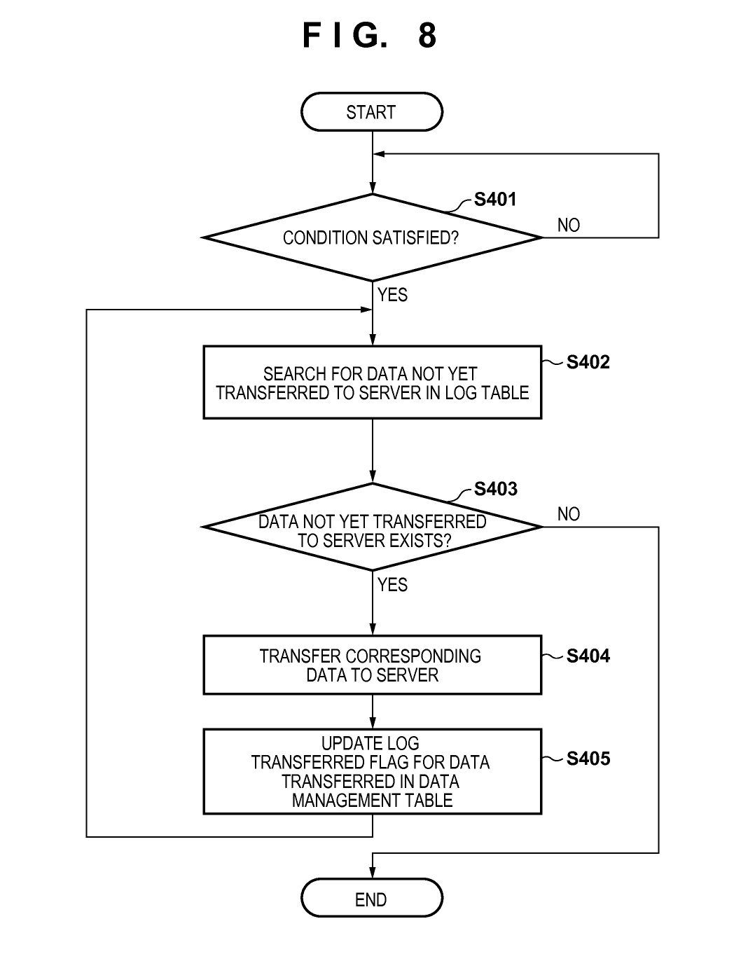

In step S402, the CPU 3003 references the log table, and if one or more JobID/job log sets are registered, it is determined that transfer to the image processing server 1001 has not been performed for those sets. Then, the processing proceeds to step S404 via step S403. Meanwhile, in a case where there is not even one JobID/job log set registered in the log table, the processing according to the flowchart of FIG. 8 completes.

In step S404, the CPU 3003 selects a set from the one or more sets registered in the log table as a selected set. Then, the CPU 3003 transmits the selected set, and the print target image in the HDD 3006 corresponding to the selected set (the print target image which is the source of the generation of the log in the selected set) towards the image processing server 1001.

In step S405, the CPU 3003 sets the transferred flag 5003 registered in the job management table with the same JobID as the JobID in the selected set to be “enabled”. Also, the CPU 3003 deletes the selected set from the log table. Then the processing returns to step S402.

After the completion of the processing according to the flowchart of FIG. 8, the CPU 3003, in step S501, determines whether or not print target image deletion instruction is input via the operation unit 3009. For example, the CPU 3003 performs a list display to the operation unit 3009 of information corresponding to each print target image (for example, the information included in the header) registered in the above described queue, and receives an instruction designating the print target images to be deleted from the user.

Then, if the result of the determination is that a deletion instruction is input, the processing proceeds to step S502. Meanwhile, in a case where a deletion instruction is not input, the processing stands by in step S501.

In step S502, the CPU 3003 references the printed flag 5002 and the transferred flag 5003 from the information for the print job for which deletion is designated in the job management table.

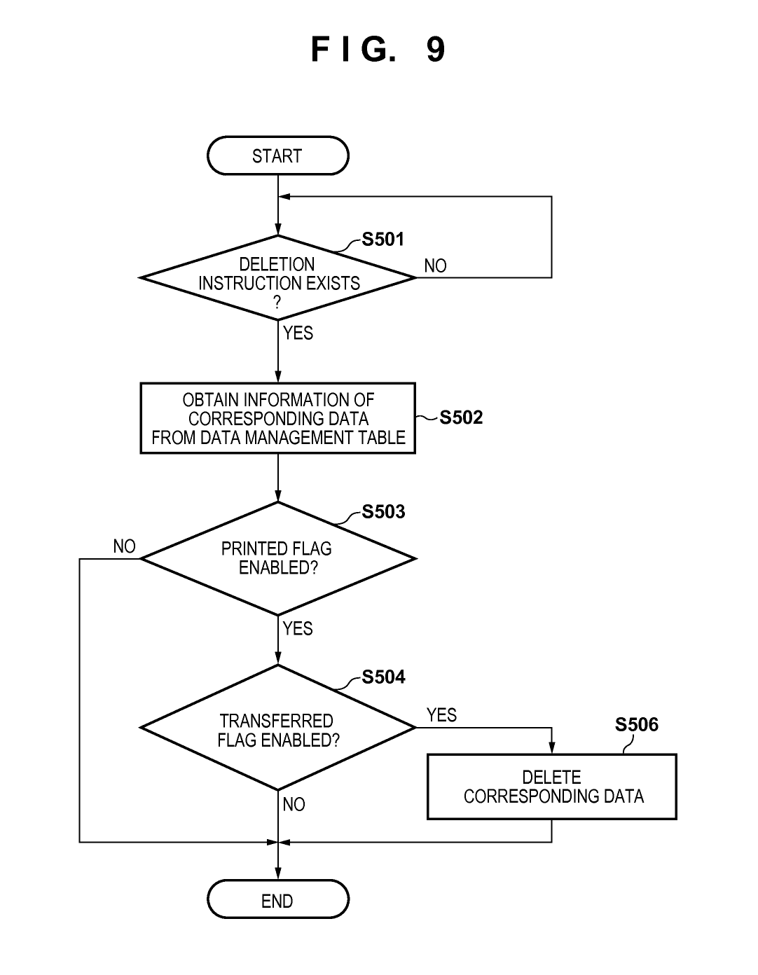

In step S503, the CPU 3003 determines whether or not the printed flag 5002 is “enabled”. If the result of the determination is that the printed flag 5002 is “enabled”, the processing proceeds to step S504. On the other hand, if the result of this determination is that the printed flag 5002 is “disabled”, the processing according to the flowchart of FIG. 9 completes.

In step S504, the CPU 3003 determines whether or not the transferred flag 5003 is “enabled”. If the result of the determination is that the transferred flag 5003 is “enabled”, the processing proceeds to step S506. On the other hand, if the result of this determination is that the transferred flag 5003 is “disabled”, the processing according to the flowchart of FIG. 9 completes.

In step S506, the CPU 3003 deletes the information for the print job for which deletion was designated in the job management table, and deletes the print target image for which deletion is designated in the queue in the HDD 3006.

Note that the print job that appears in the present embodiment may be a so-called save job (a print job managed using a box function) that is first saved in the HDD 3006, and afterwards printed when the user later designates it by operating the operation unit 3009. Also, the print job that appears in the present embodiment may be a print job that the printer 1005 prints as is without first saving when the print job is received.

In this way, by virtue of the present embodiment, it is not necessary to provide an image for each intended use because the image used for the printing and the image used to generate the log are the print target image which is registered in the HDD 3006. Also, because the print target image is deleted after the printing and the log transmission is completed, it is possible to prevent the print target image being left in the memory unnecessarily.

### Second Embodiment

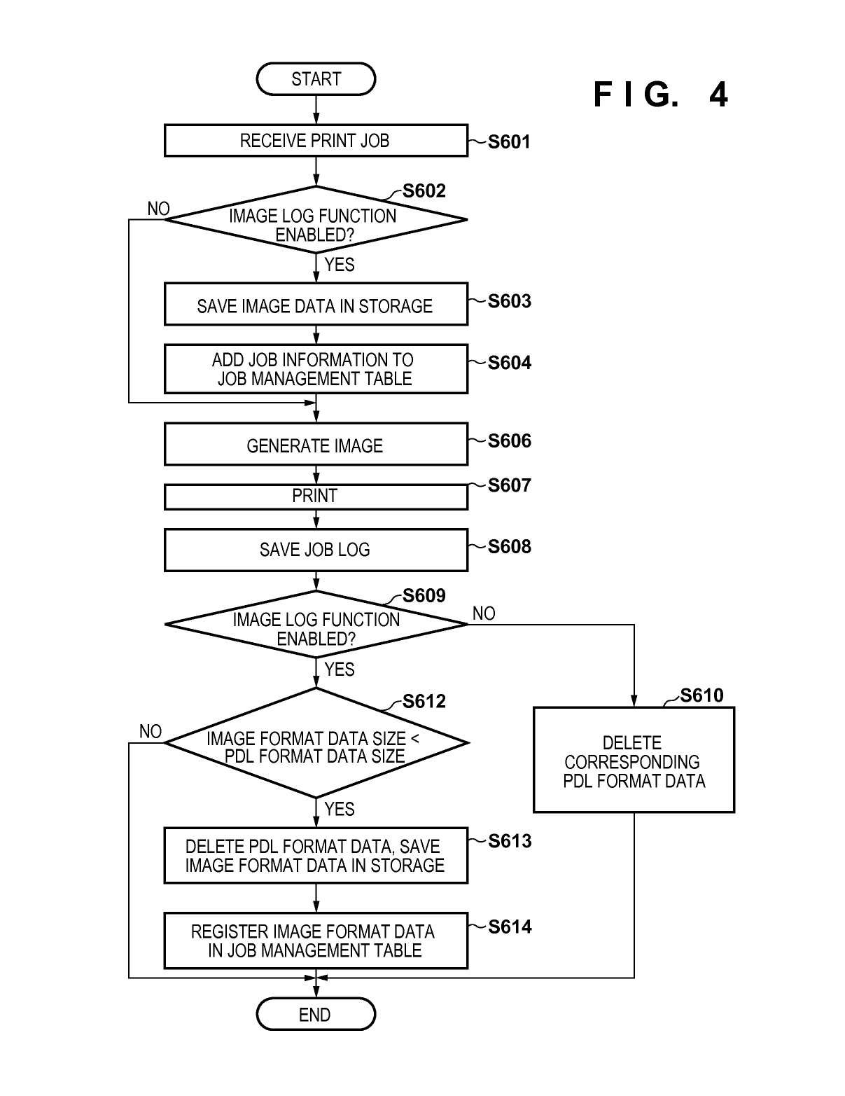

In the present embodiment, the printer 1005 receives data in a PDL format from the host computer 1004 as a print job, and controls as follows. In other words, when registering in the queue, whichever of the data in the PDL format, and the result of converting the data in the PDL format into data of a bitmap format has a smaller data amount is registered. In this case, the processing is different to the first embodiment on the point that in place of the processing according to the flowchart of FIG. 7, the processing according to the flowchart of FIG. 4 is executed. Below, explanation will be omitted for points that are the same as in the first embodiment, and predominantly points of difference with the first embodiment will be explained. In other words, it is assumed that the following is the same as in the first embodiment so long as it is not touched upon particularly.

In FIG. 4, because step S601-step S609 is the same as step S101-step S109 of FIG. 7 respectively, the explanation for these steps will be omitted. However, explanation will be given for the processing of step S610-step S616 below.

In step S610, the CPU 3003 deletes the data in the PDL format which was stored in the RAM 3004 in step S601 and held in the RAM 3004 as is.

In step S612, the CPU 3003 generates data in a bitmap format from the data in the PDL format. Then the CPU 3003 performs a large/small comparison of the data size of the data in the PDL format and the data in the bitmap format. If the result of the large/small comparison is that the data size of the data in the PDL format>the data size of the data in the bitmap format, the processing proceeds to step S613. Meanwhile, if the data size of the data in the PDL format<the data size of the data in the bitmap format, the processing according to the flowchart of FIG. 4 is caused to complete.

In step S613 the CPU 3003 deletes the data of the PDL format caused to move into the queue in step S603, and instead registers the data in the bitmap format generated in step S612.

In step S614, the CPU 3003 rewrites, in accordance with the data in the bitmap format, information according to a format of the print target image from the information registered in the job management table in step S604. The information for the format of the print target image is, in other words, information that has an effect by the data in the bitmap format being registered as the print target image in place of the data in the PDL format.

Note that data having another format such as data of a JPEG format, data of a TIFF format, or the like, may be used in place of the data in the PDL format. Of course, the same is true for the data in the bitmap format.

Also, in the first and second embodiments explanation was given having the print job be transmitted from the host computer 1004, but configuration may be taken such that the print jobs are transmitted from another device, and configuration may be taken such that the print jobs are received from a device that is detachably attachable to the printer 1005. Also, configuration may be taken such that the print jobs are jobs that are input by the user operating the operation unit 3009. For example, in the case of a multi-function peripheral including the printer 1005, when the user inputs a copy instruction using the multi-function peripheral, the multi-function peripheral sends an image read by a scanner to the printer 1005 as the print job. In other words, in such a case, the print job is a job that is generated in the multi-function peripheral. In this way, various embodiments can be considered for the form in which print jobs are supplied to the printer 1005, and there is no limitation to a particular embodiment.

Also, in the first and second embodiments, explanation was given having the print target image be data included in a print job, but the print target image may be an image obtained as a result of rendering based on data included in a print job.

Also, in the first and second embodiments, the processing is performed using two types of tables (the job management table 5001 of FIG. 5 and the log table 7001 of FIG. 6), but configuration may be taken such that more tables are generated in accordance with the roles of the tables.

For example, in the first and second embodiments, the log table is managed for logs that have not yet been transferred to the image processing server 1001, but not yet transferred logs and already transferred logs may be managed in separate tables.

Also, in the first and second embodiments, the printed flag 5002 and the transferred flag 5003 are managed in one table (the job management table), but configuration may be taken such that each flag is managed in a separate table.

Also, configuration may be taken such that a flag that indicates whether or not the state (a state where the printed flag 5002 is “enabled” and the transferred flag 5003 is “enabled”) is “already printed and already transferred” is used in place of the printed flag 5002 and the transferred flag 5003.

Also, configuration may be taken such that the various embodiments and variations explained above are used in combination as appropriate.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-097109, filed May 8, 2014, which is hereby incorporated by reference herein in its entirety.

What is claimed is:

1. An image processing apparatus, comprising:
a storage unit configured to store an image;
a print unit configured to print the image stored by the storage unit;
a transmission unit configured to generate a log for the image stored by the storage unit, and transmit the generated log and the image to an external device; and
a deletion unit configured to delete the image stored by the storage unit after the transmission and the printing are completed.

2. The image processing apparatus according to claim 1, wherein the transmission unit, if a data size when a format of the image is converted is smaller than a data size of the image, transmits to the external device the generated log and an image after the format of the image is converted in place of the image.

3. The image processing apparatus according to claim 1, wherein the deletion unit deletes, after the transmission and the printing are completed, the image stored by the storage unit in a case where a deletion instruction from a user is input.

4. The image processing apparatus according to claim 1, wherein the deletion unit causes the storage unit to store the image stored by the storage unit, not deleting the image stored by the storage unit until the transmission and the printing are completed.

5. An image processing method that an image processing apparatus performs, the method comprising:
a storage step of storing an image in a memory;
a print step of printing the image stored in the memory;
a transmission step of generating a log for the image stored in the memory, and transmitting the generated log and the image to an external device; and
a deletion step of deleting the image stored in the memory after the transmission and the printing are completed.

6. A non-transitory computer-readable storage medium storing a computer program for causing a computer to execute:
a storage step of storing an image in a memory;
a print step of printing the image stored in the memory;
a transmission step of generating a log for the image stored in the memory, and transmitting the generated log and the image to an external device; and
a deletion step of deleting the image stored in the memory after the transmission and the printing are completed.
